(19) United States
(12) Patent Application Publication
(10) Pub. No.: US 2018/0141725 A1
(43) Pub. Date: May 24, 2018

(54) UNIVERSAL ENCLOSURE ATTACHMENT

(71) Applicant: John Karamanos, San Jose, CA (US)

(72) Inventors: John Karamanos, San Jose, CA (US); Douglas Mahadocon, San Jose, CA (US)

(21) Appl. No.: 15/876,803

(22) Filed: Jan. 22, 2018

Related U.S. Application Data
(63) Continuation of application No. 14/735,726, filed on Jun. 10, 2015.

(51) Int. Cl. B65D 43/20; E05D 15/48; B65D 43/16; E05D 1/06

(52) U.S. Cl. CPC B65D 43/20; E05D 15/48; E05D 2015/485; E05D 1/06; B65D 43/16

(57) ABSTRACT

An enclosure assembly having a housing and a cover attached to the housing, wherein the cover can either swing open and/or slide open partially or be removed completely from the enclosure housing for access to the space within the enclosure.

### RELATED APPLICATION

The present application is a continuation of, and claims priority to, U.S. patent application Ser. No. 14/735,726, filed Jun. 10, 2015, and entitled “UNIVERSAL ENCLOSURE ATTACHMENT,” the entirety of which is hereby incorporated by reference herein.

### FIELD OF THE INVENTION

This invention pertains generally to attachment of lids, covers, or doors to enclosures or housings, and more particularly to an attachment system that allows a cover to be either swung open or slid off the enclosure that is attached thereto.

### BACKGROUND OF THE INVENTION

Enclosure assemblies are universally used to secure and protect its contents and also to allow for convenient transportation of contents from one place to another. Accessibility to store and remove contents within the enclosure assembly is an essential function of the enclosure assembly, and this function is typically accomplished using a lid or cover in conjunction with the enclosure housing. Such lids or covers are attached to the enclosure housing by either relatively permanent or temporary means. Relatively permanent systems of attaching a cover to its enclosure housing may include screws, nuts and bolts, welding and the like. A relatively permanent attachment renders the enclosure's opening practically inaccessible in the field as the cover cannot be quickly removed and/or removed without the use of tools. Temporary attachment systems are typically snap-type fittings or hinges. Snap-type fittings secure the lid over the opening of the enclosure housing and allows for the cover's removal therefrom by unsnapping the cover from the enclosure housing to provide access to the space within the enclosure. Hinges allow the cover to swing away from the enclosure housing to which it is attached, thereby providing access to the space within the enclosure.

A problem exists with current attachment systems as they are based on different design concepts that require differing manufacturing techniques, and a multitude of different designs increases manufacturing and inventory costs. Moreover, the currently known attachment systems fail to provide the flexibility when accessing the space within the enclosure to either remove the cover in its entirety or just swing the cover away from the enclosure housing.

Accordingly, there is a need for an enclosure assembly that offers the flexibility of a cover that can swing open with an attachment system and/or slide open either partially or be removed completely from the enclosure housing for access to the space within the enclosure. A single attachment system solving this problem can meet the needs of all the aforementioned various applications and minimizes costs of manufacturing, inventory, and the like.

### SUMMARY OF THE INVENTION

One aspect of the invention is an attachment system that attaches a lid or cover to an enclosure housing that allows for the lid or cover to swing open from the enclosure housing.

Another aspect of the invention is an attachment system that attaches a lid or cover to an enclosure housing wherein the attachment system allows for the lid or cover to slide open from the housing or enclosure.

Yet another aspect of the invention is an attachment system that attaches a lid or cover to an housing or enclosure wherein lid or cover can to be slidably removed completely from the enclosure housing.

These and various other advantages and features of novelty which characterize the invention are pointed out with particularity in the claims that follow and form a part hereof. However, for a better understanding of the invention, its advantages, and the objects obtained by its use, reference should be made to the drawings which also form a further part hereof, and to accompanying descriptive matter, in which there are illustrated and described specific examples of an apparatus in accordance with the invention.

### BRIEF DESCRIPTION OF THE DRAWINGS

The invention will be more fully understood by reference to the following drawings which are for illustrative purposes only:

FIG. 1 is a perspective view of an enclosure assembly with the cover partly swung open from the enclosure housing in accordance with one embodiment of the present invention.

FIG. 2 is a side view of the enclosure assembly in accordance with the present invention with the cover closed.

FIG. 3 is a perspective view of the enclosure assembly shown in FIG. 1 with the cover mostly swung open in accordance with the present invention.

FIGS. 4A and 4B are perspective views of an enclosure assembly with a cover partly slid open in accordance with another embodiment of the present invention.

FIG. 5 is an enlarged view of an attachment system of the enclosure assembly in accordance with the invention.

FIG. 6 is an enlarged view of a component of the attachment system shown in accordance with the invention.

FIG. 7 is an enlarged view of a component of the attachment system shown in accordance with the invention

### DETAILED DESCRIPTION OF THE INVENTION

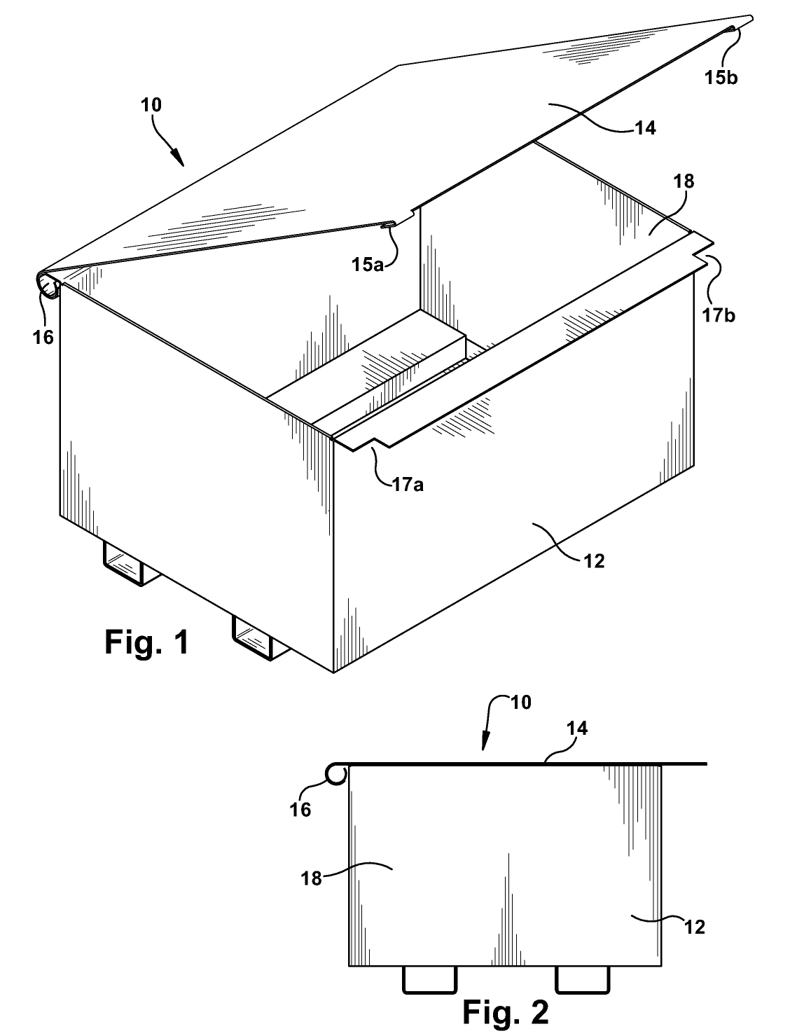

Referring more specifically to the drawings, for illustrative purposes the present invention is embodied in the apparatus generally shown in FIG. 1 through FIG. 7. It will be appreciated that the apparatus may vary as to configuration and as to details of the parts without departing from the basic concepts as disclosed herein.

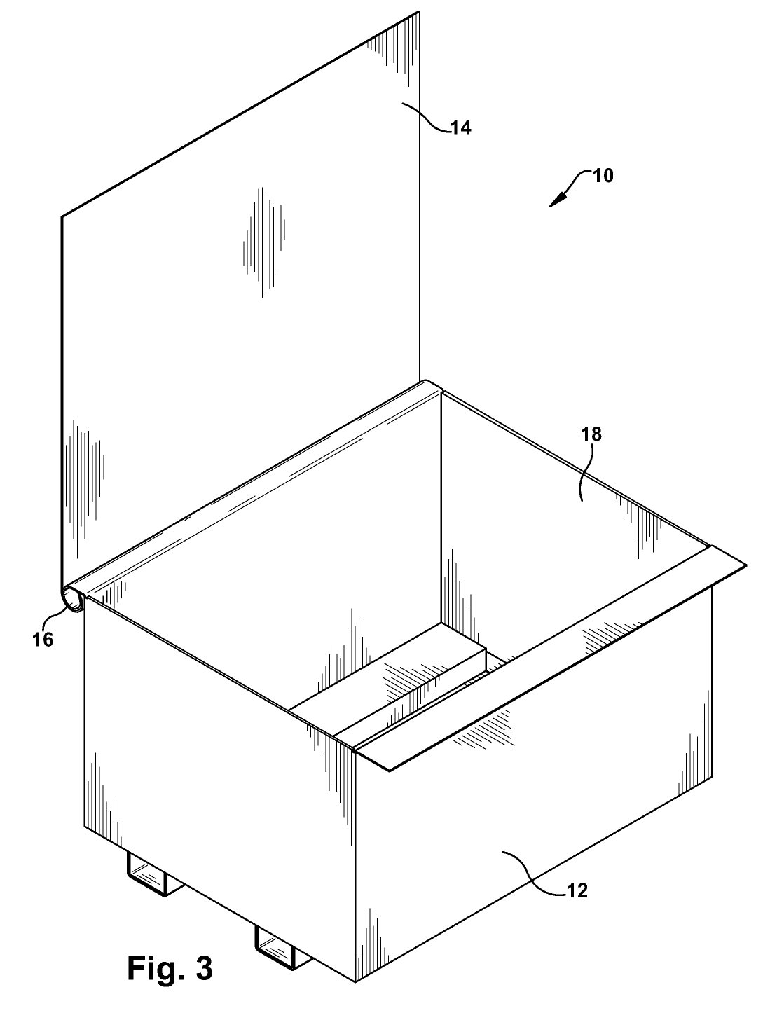

Referring first to FIG. 1 through FIG. 3, an enclosure assembly 10 embodying the present invention is generally shown. Enclosure assembly 10 generally comprises an enclosure housing 12, an enclosure cover 14 and an attachment system 16 for attaching enclosure cover 14 to the enclosure housing 12. Enclosure cover 14 is shown in a partly swung open position from the enclosure housing 12 thereby providing partial access to a space 18 within enclosure housing 12. Referring now to FIG. 2, a side view of the enclosure assembly 10 of the present invention is generally shown. As can be seen in the figure, enclosure cover 14 is shown on a completely closed position relative to enclosure housing 12 thereby sealing space 18 within enclosure housing 12. The sealing of space 18 of the enclosure housing 12 may provide an airtight, watertight, or hermetic seal to isolate the space 18 from the environment as necessary, depending on the application. The composition of materials used in the fabrication of enclosure assembly 10 may be metal, plastic, wood, or any suitable material structurally suitable for its intended purpose. In FIG. 3, enclosure assembly is shown with enclosure cover 14 in a mostly swung open position relative to enclosure housing 12 thereby providing full access to space 18 within enclosure 12. As seen in FIG. 1, enclosure cover 14 may include rolled tabs 15a and 15b that clear notches 17a and 17b disposed on a lip that extends from enclosure housing 12 thereby allowing enclosure cover 14 to swing away from enclosure housing 12. It can be seen that when enclosure cover 14 is on the closed position, sliding enclosure cover 14 in either longitudinal direction will cause rolled tabs 15a and 15b to engage the lip, thereby preventing enclosure cover 14 from swinging open.

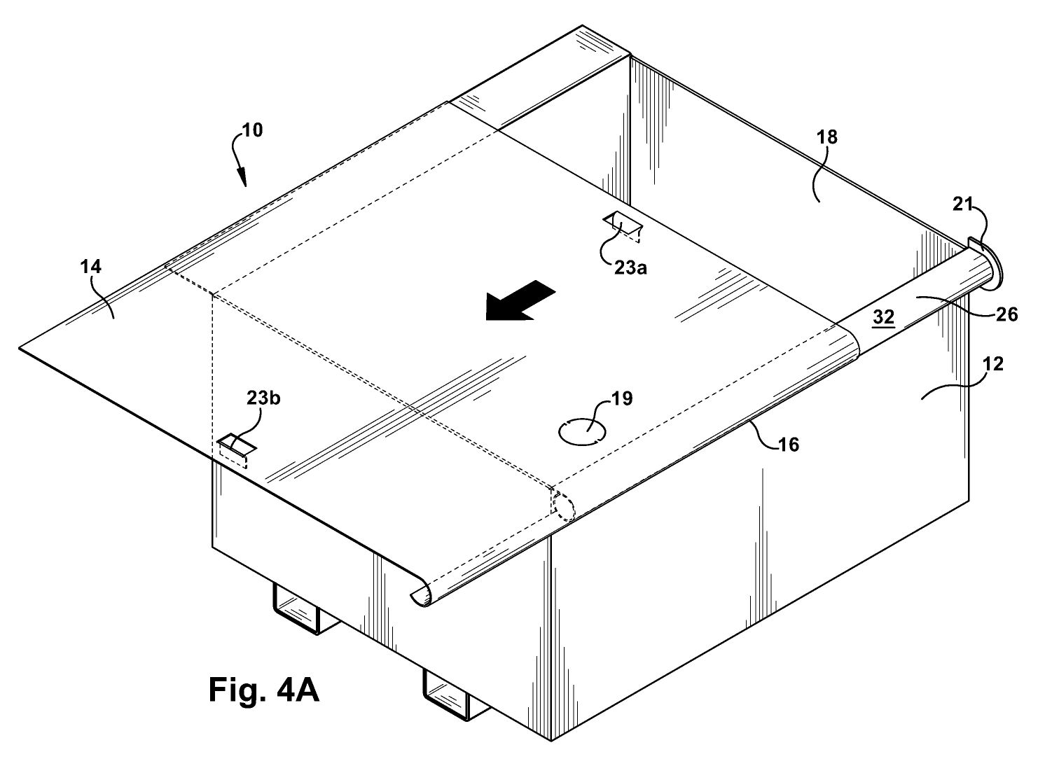

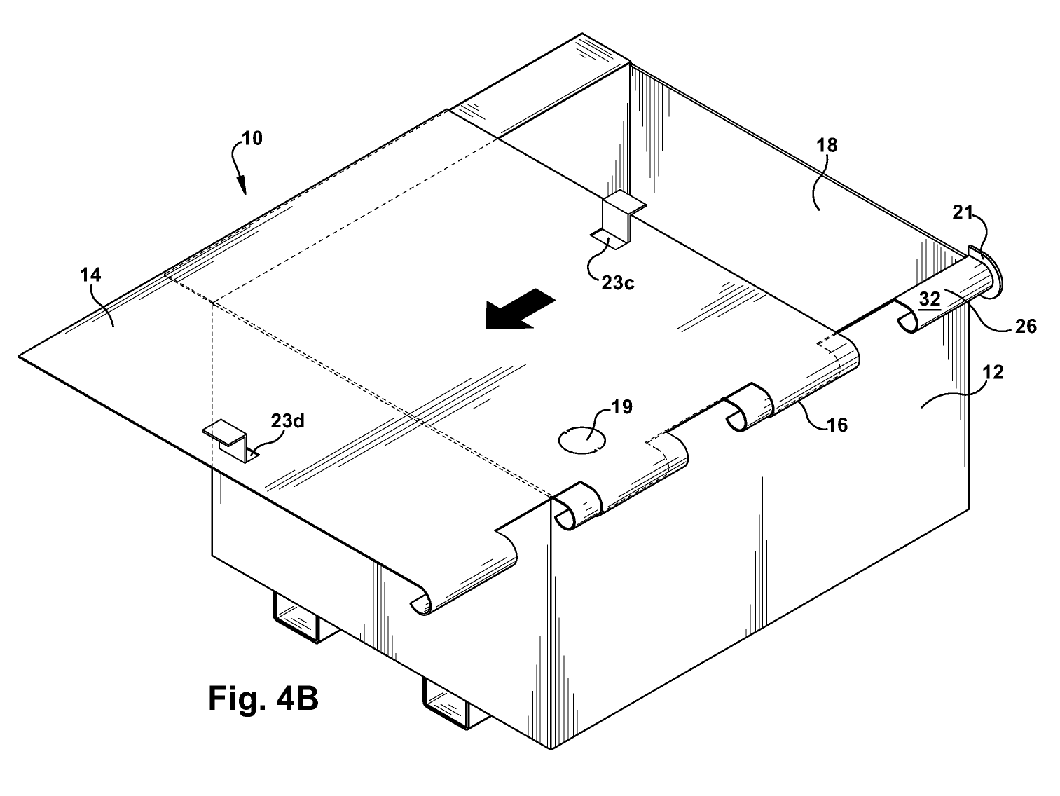

Referring now to FIGS. 4A and 4B, enclosure assembly 10 is shown, wherein enclosure cover 14 is depicted in a partially slid open position relative to enclosure housing 12. In this position shown, partial access to space 18 within enclosure housing 12 is provided. The arrow shown in the figure is a longitudinal direction that exemplifies how enclosure cover 14 may be slidably moved longitudinally relative to enclosure housing 12 to provide partial access to space 18. It is contemplated the cover 12 may also be slidably moved in a longitudinal direction to the opposite of that shown by the arrow to also provide partial access to space 18. When enclosure cover 14 is slidably moved beyond the edge of enclosure housing 12 in either direction, enclosure cover 14 may be completely detached from enclosure housing 12 thereby providing full access to space 18 within enclosure 12. Cylindrical receiving member 26 (described below) may also incorporate a flange 21 disposed at one end to limit the longitudinal movement of enclosure cover 14 and/or to maintain enclosure cover 14 in a fixed position relative to enclosure housing 12. It is contemplated that knockout hole(s) 19 may be incorporated in enclosure housing 12 or enclosure cover 14 that will offer access of the internal components to external elements, such as electrical wiring, plumbing, computer displays, etc. Bent tabs 23 may also be incorporated on enclosure cover 14 and disposed at approximately each longitudinal end thereof. Bent tabs 23 may be bent upward away from space 18 as shown in 23c and 23d or downward into space 18 as shown in 23a and 23b of enclosure housing 12. For example, when bent tab 23a is bent upward, it may serve as a grab handle for enclosure cover 14, and when bent tab 23b is bent downward, it locks enclosure cover 14 in place and prevents its sliding relative to enclosure housing 12.

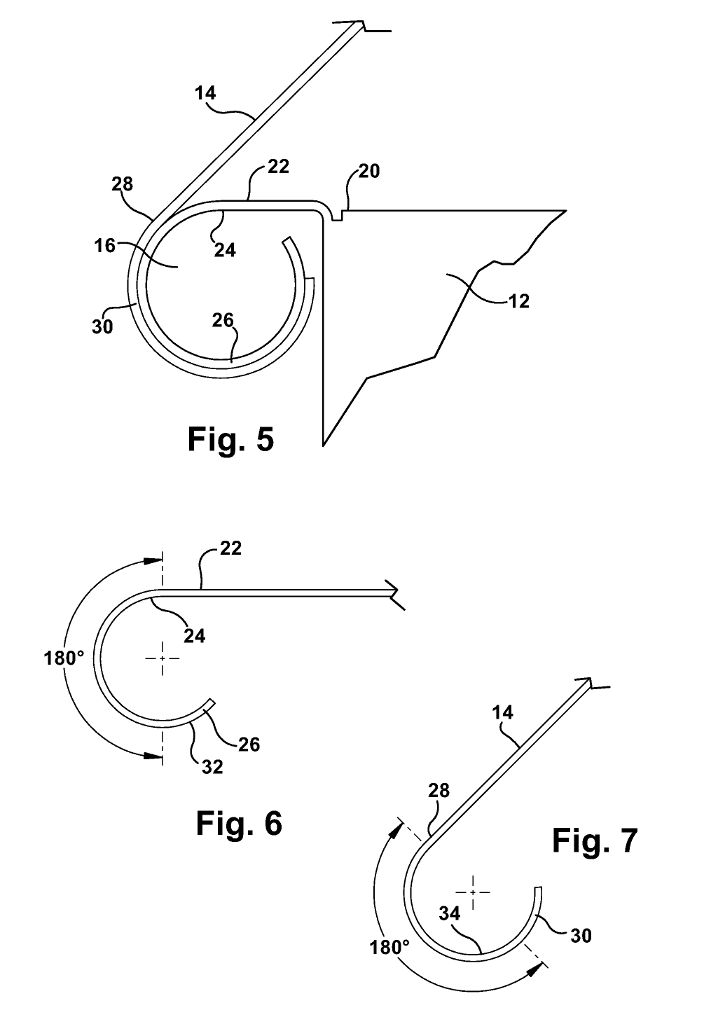

Referring to FIG. 5, an enlarged view of attachment system 16 of enclosure assembly 10 is generally depicted. At least one edge 20 of enclosure housing 12 comprises a lip 22. The distal end 24 of lip 22 extends to and forms a cylindrical receiving member 26. At least one side 28 of enclosure cover 14 extends to and forms a cylindrical engaging member 30. Cylindrical engaging member 30 surrounds and slidably engages cylindrical receiving member 26 concentrically, while allowing enclosure cover 14 to pivot around a central axis of cylindrical receiving member 26, thereby causing enclosure cover 14 to swing open or close relative to enclosure housing 12.

In FIG. 6, cylindrical receiving member 26 comprises a curved outer bearing surface 32 that extends about 180 degrees around from distal end 24 of lip 22 as shown. Those skilled in the art will appreciate that the angle that outer bearing surface 32 extends may be somewhat greater to or less than 180 degrees but primarily sufficient to receive and allow articulation of cylindrical receiving member 26 relative to cylindrical engaging member 30. Cylindrical receiving member 26 may be a rolled sheet panel as depicted or also a solid cylindrical piece.

In FIG. 7, cylindrical engaging member 30 comprises a curved inner bearing surface 34 that extends at least greater than about 180 degrees from side 28 of enclosure cover 14. Inner bearing surface 34 of cylindrical engaging member 30 articulates directly with outer bearing surface 32 of cylindrical receiving member 26 and allows enclosure cover 14 to pivot around a central axis of cylindrical receiving member 26, thereby causing enclosure cover 14 to swing open or close relative to enclosure housing 12. Additionally, the articulation of inner bearing surface 34 with outer bearing surface 32 also allows enclosure cover 14 to move longitudinally relative to enclosure housing 12. Flange 21 of cylindrical receiving member 26 may serve as a stop to prevent enclosure cover 14 from longitudinally traversing therebeyond. Curved inner bearing surface 34 must extend at least greater than 180 degrees around to adequately secure cylindrical engaging member 30 to cylindrical receiving member 26 and provide their relative articulation. The outer diameter of cylindrical receiving member 26 may vary so long as it allows for matching engagement with the inner radius of cylindrical engaging member 30 and proper articulation between both components.

Accordingly, it can be seen that this invention provides for enclosure assembly 10 that offers the flexibility for enclosure cover 14 that can function to both swing open and/or slide open either partially or be removed completely from enclosure housing 12 for access to space 18 within the enclosure housing 12 as a result of the engagement and articulation of cylindrical receiving member 26 with cylindrical engaging member 30. Additionally, it can be seen that attachment system 16 of the present invention provides for two degrees of freedom, namely longitudinally translation and axial rotation of cylindrical receiving member 26 relative to cylindrical engaging member 30. The longitudinally translation and axial rotation of cylindrical receiving member 26 relative to cylindrical engaging member 30 may also occur simultaneously and not necessarily in separate discrete movements.

Although the description above contains many specificities, these should not be construed as limiting the scope of the invention but as merely providing illustrations of some of the presently preferred embodiments of this invention. Thus the scope of this invention should be determined by the appended claims and their legal equivalents.

What is claimed is:

1. An enclosure assembly apparatus, comprising:
an enclosure housing with an opening at a top side of the enclosure housing, wherein the enclosure housing at least partially encloses a volume of space and comprises:
a left wall at a left side of the enclosure housing;
a right wall at a right side of the enclosure housing that is substantially parallel to left wall; and
a back wall at a back side of the enclosure housing that is substantially perpendicular to, and coupled to, the left wall and the right wall; and
an enclosure cover configured to cover the top side of the enclosure housing; and
an attachment mechanism configured to removably attach the enclosure cover to the enclosure housing in a manner that permits (i) a detachment procedure in which the enclosure cover detaches from the enclosure housing, (ii) a pivoting procedure in which the enclosure cover pivots at the back wall, exposing the volume of space; and (iii) a sliding procedure in which the enclosure cover slides along the top side of the enclosure housing, exposing the volume of space.

2. The enclosure assembly apparatus of claim 1, wherein the attachment mechanism is configured to permit the detachment procedure in response to the sliding procedure in which the enclosure cover slides in a direction along the top side of the enclosure housing more than a length, in the direction, of the enclosure cover.

3. The enclosure assembly apparatus of claim 1, wherein the attachment mechanism comprises a first portion that is coupled to the enclosure housing and a second portion that is coupled to the enclosure cover.

4. The enclosure assembly apparatus of claim 3, wherein the first portion and the second portion are coupled during the pivoting procedure.

5. The enclosure assembly apparatus of claim 3, wherein the first portion and the second portion reattachably decouple during the detachment procedure.

6. The enclosure assembly apparatus of claim 3, wherein the first portion comprises a first arcing member situated proximal to an intersection between the left wall and the back wall and a second arcing member situated proximal to an intersection between the right wall and the back wall.

7. The enclosure assembly apparatus of claim 6, wherein the first arcing member extends in an arc that is at least 180 degrees about a center point of the first arcing member.

8. The enclosure assembly apparatus of claim 7, wherein the second portion comprises a first inserting member and a second inserting member, wherein the first inserting member is configured to insert into a space, comprising the center point, of the first arcing member.

9. The enclosure assembly apparatus of claim 8, wherein the first inserting member remains in the space during the pivoting procedure.

10. The enclosure assembly apparatus of claim 8, wherein the first inserting member recedes from the space during the detachment procedure.

11. A control panel enclosure assembly, comprising:
an enclosure housing, having at least a partially cuboid shape, with an opening at a top side of the enclosure housing, wherein the enclosure housing encloses a control panel device and comprises:
a left wall at a left side of the enclosure housing;
a right wall at a right side of the enclosure housing that is substantially parallel to left wall; and
a back wall at a back side of the enclosure housing that is substantially perpendicular to, and coupled to, the left wall and the right wall;
an enclosure cover configured to cover the top side of the enclosure housing; and
an attachment mechanism configured to removably attach the enclosure cover to the enclosure housing in a manner that permits the enclosure cover to (i) detach from the enclosure housing, (ii) pivot open to expose the control panel device by pivoting at the back wall; and (iii) slide open to expose the control panel device by sliding along the top side of the enclosure housing.

12. The control panel enclosure assembly of claim 11, wherein the attachment mechanism is configured to permit the enclosure cover to detach from the enclosure housing in response to the enclosure cover sliding, in a direction, along the top side of the enclosure housing more than a length, in the direction, of the enclosure cover.

13. The control panel enclosure assembly of claim 11, wherein the attachment mechanism comprises a first portion that is coupled to the enclosure housing and a second portion that is coupled to the enclosure cover.

14. The control panel enclosure assembly of claim 13, wherein the first portion and the second portion reattachably decouple to permit the enclosure cover to slide along the top side of the enclosure housing.

15. The control panel enclosure assembly of claim 13, wherein the first portion comprises a first arcing member situated proximal to an intersection between the left wall and the back wall and a second arcing member situated proximal to an intersection between the right wall and the back wall.

16. The control panel enclosure assembly of claim 15, wherein the first arcing member extends in an arc that is at least 180 degrees about a center point of the first arcing member.

17. The control panel enclosure assembly of claim 16, wherein the second portion comprises a first inserting member and a second inserting member, wherein the first inserting member is configured to insert into a space comprising the center point of the first arcing member.

18. The control panel enclosure assembly of claim 17, wherein the attachment mechanism permits the enclosure cover to pivot open or closed in response to the first arcing member pivoting around the first inserting member.

19. The control panel enclosure assembly of claim 17, wherein the attachment mechanism permits the enclosure cover to slide along the top side of the enclosure housing in response to the first inserting member receding from the space.

20. The control panel enclosure assembly of claim 17, wherein the attachment mechanism permits the enclosure cover to detach from the enclosure housing in response to the first inserting member receding from the space.
